(19) United States
(12) Patent Application Publication
(10) Pub. No.: US 2026/0270308 A1
(43) Pub. Date: Sep. 10, 2026

(54) File Transfer Protocol over CoAP with Adaptive Transmission

(71) Applicant: Silicon Laboratories Inc., Austin, TX (US)

(72) Inventor: Istvan Milak, Monorierdo (HU)

(21) Appl. No.: 19/071,868

(22) Filed: Mar. 6, 2025

(51) Int. Cl. H04L 67/06

(52) U.S. Cl. CPC H04L 67/06

(57) ABSTRACT

A system and method of transferring files from a host device to a network device is disclosed. The system and method uses constrained application protocol (CoAP) to transfer the file to the network device. Non-confirmable messages are used for the transfer. The host device transmits a plurality of PUT requests to transfer the data chunks to the network device. Once all of the data chunks are transmitted, the host device transmits a PUT request indicating that all data chunks have been transmitted. The network device then either responds with a message indicating success or provides a list of data chunks that were not received. In some embodiments, feedback from the network device is used to modify one or more parameters of the file transfer.

### FIELD

This disclosure describes systems and methods for transferring files between two devices, such as by using a wireless network.

### BACKGROUND

The Internet of Things (IoT) has led to an explosion in the number of network devices that are available. In some of these devices, it may be necessary to perform updates of the installed software to correct software issues or add new functionality. However, in certain network devices, the size of the software image may be very large, such as several hundred kilobytes.

Many conventional file transfer protocols, such as Trivial File Transfer Protocol (TFTP), require the transmission of an acknowledgment after each packet of data. This consumes network bandwidth and slows the overall transfer time, as the server needs to wait for an acknowledgment of a first packet before it can send a second packet.

Furthermore, the networks used by these network devices may be lossy, implying that packets sent by the server may be lost without reaching the network device.

Therefore, it would be beneficial if there was a file transfer protocol that handled lossy networks without requiring all of the acknowledgments needed by existing file transfer protocols. Further, it would be advantageous if this file transfer protocol operated using different network physical layers, had low power consumption and was able to adapt to changing network conditions.

### SUMMARY

A system and method of transferring files from a host device to a network device is disclosed. The system and method uses constrained application protocol (CoAP) to transfer the file to the network device. Non-confirmable messages are used for the transfer. The host device transmits a plurality of PUT requests to transfer the data chunks to the network device. Once all of the data chunks are transmitted, the host device transmits a PUT request indicating that all data chunks have been transmitted. The network device then either responds with a message indicating success or provides a list of data chunks that were not received. In some embodiments, feedback from the network device is used to modify one or more parameters of the file transfer.

According to one embodiment, a system for wirelessly transferring a file is disclosed. The system comprises a host device; and a network device; wherein constrained application protocol (CoAP) is used to transmit requests and responses between the host device and the network device; wherein the file is divided into a plurality of data chunks; wherein only non-confirmable messages are used to transfer the file; and wherein the host device comprises a controller that modifies at least one parameter of the transfer based on feedback from the network device. In some embodiments, the at least one parameter of the transfer that is modified comprises an interval between transmission of successive data chunk PUT requests, referred to as a transmission interval (T). In certain embodiments, the feedback comprises a number or percentage of data chunk PUT requests that were not received by the network device. In certain embodiments, the feedback comprises a change in received transmission interval (dTr). In some embodiments, the controller comprises a fuzzy controller.

According to another embodiment, a method of wirelessly transferring a file between a host device and a network device is disclosed. The method comprises using constrained application protocol (CoAP) to transmit requests and responses between the host device and the network device; wherein the file is divided into a plurality of data chunks; and only non-confirmable messages are used to transfer the file. In some embodiments, the host device uses data chunk PUT requests to transmit the file to the network device, wherein each data chunk PUT request contains one of the plurality of data chunks. In certain embodiments, the host device transmits an End of Chunks (EOC) PUT request to indicate that all of the plurality of data chunks have been transmitted. In certain embodiments, the network device transmits a Retransmission List request in response to the EOC PUT request if all of the plurality of data chunks were not received, wherein the Retransmission List request contains a list of identifiers of data chunks that were not received and wherein, in response to the Retransmission List request, the host device uses the list of identifiers to retransmit data chunks that were not received using data chunk PUT requests. In certain embodiments, the network device transmits a Transfer Successful request in response to the EOC PUT request if all of the plurality of data chunks were received. In some embodiments, the network device transmits a GET request to the host device to request the transfer of the file, and wherein the host device transmits a response to the GET request that provides parameters about the file and/or the transfer, wherein the parameters are one or more of file name, file size, data chunk size or number of data chunks. In some embodiments, the network device transmits a GET request to the host device to request a list of available files, the host device responds to the GET request with a list of available files, the network device selects a file from the list of available files and transmits a GET request to the host device to request the transfer of the file. In some embodiments, the network device transmits a Statistics PUT request to the host device, the Statistics PUT request comprising parameters associated with transmission of the plurality of data chunks. In certain embodiments, the network device transmits the Statistics PUT request after a missing or lost data chunk is detected. In certain embodiments, the host device uses the parameters associated with the transmission of the plurality of data chunks to modify a transmission interval, which is defined as an interval between transmission of successive data chunk PUT requests. In certain embodiments, the parameters associated with transmission of the plurality of data chunks comprise at least one of a number of data chunks that were not received, a percentage of data chunks that were not received, or a change in received transmission interval. In certain embodiments, the host device uses a fuzzy controller to modify the transmission interval.

According to another embodiment, a network device adapted to receive a file from a host device is disclosed. The network device comprises a network interface; a processing unit; and a memory device in communication with the processing unit, containing instructions, which when executed by the processing unit, enable the network device to: receive a plurality of Data Chunk PUT requests from the host device, wherein each Data Chunk PUT request is transmitted using non-confirmatory messages via constrained application protocol (CoAP), and wherein each Data Chunk PUT request contains a chunk of data associated with the file; receive an End Of Chunks (EOC) PUT request from the host device, wherein the EOC PUT request is transmitted using a non-confirmatory message via CoAP; and transmit a request back to the host device in response to the EOC PUT request, wherein the request is transmitted using a non-confirmatory message via CoAP. In some embodiments, the network device transmits a Transfer Successful request if all of the chunks of data were successfully received, and transmits a Retransmission List request if one or more data chunks were not received. In some embodiment, the network device comprises instructions, which when executed by the processing unit, enable the network device to transmit a GET request to the host device to request the transfer of the file, and receive a response from the host device that provides parameters about the file and/or the transfer, wherein the parameters are one or more of file name, file size, data chunk size or number of data chunks.

### BRIEF DESCRIPTION OF THE DRAWINGS

For a better understanding of the present disclosure, reference is made to the accompanying drawings, in which like elements are referenced with like numerals, and in which:

FIG. 1 shows a block diagram of a wireless network device according to one embodiment;

FIG. 2 shows the software layers used by the disclosed file transfer protocol;

FIG. 3 shows the configuration of the network device and host device according to one embodiment;

FIG. 4A shows a diagram illustrating the packets needed to complete a file transfer from the host device to the network device;

FIGS. 4B-4C show variations of the diagram shown in FIG. 4A;

FIG. 5 shows a flowchart of the operation of the host device and the network device according to one embodiment;

FIG. 6 shows the format of the various requests and responses according to one embodiment; and

FIG. 7 shows the operation of the controller in determining the interval between successive Data Chunk requests.

### DETAILED DESCRIPTION

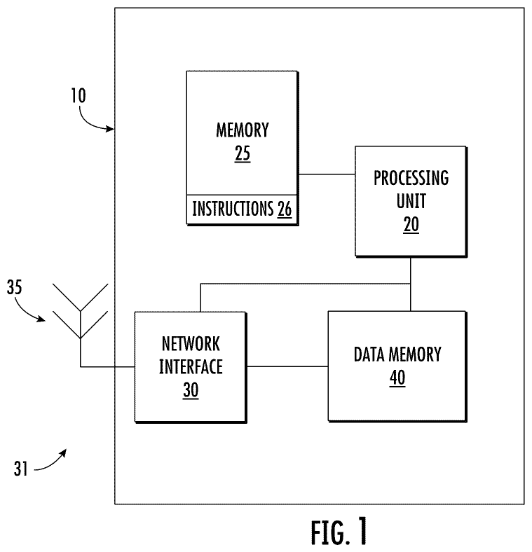

FIG. 1 shows a block diagram of a representative network device 10 that is able to receive a file transferred using the disclosed CoAP file transfer protocol.

The network device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the network device 10 to perform the functions described herein. This memory device 25 may be a non-volatile memory, such as a FLASH ROM, an electrically erasable ROM or other suitable device. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CDROM, or a different memory device, which is located remote from the network device 10. The instructions contained on this second computer readable non-transitory media may be downloaded onto the memory device 25 to allow execution of the instructions by the network device 10.

The network device 10 also includes a network interface 30, which may be a wireless interface that connects with an antenna 35. The network interface 30 may support any suitable wireless network, such as WiFi, Wi-SUN, OpenThread, and other networks that support UDP (user datagram protocol) and the IP stack. The network interface 30 includes a transmit circuit which is used to transmit data from this network device 10 using the antenna 35. The network interface 30 also includes a receive circuit which is used to receive packets from any of the plurality of networks.

The network device 10 may include a data memory device 40 in which data that is received and transmitted by the network interface 30 is stored. This data memory device 40 is traditionally a volatile memory. The processing unit 20 has the ability to read and write the data memory device 40 so as to communicate with the other nodes in the wireless network 31. Although not shown, the network device 10 also has a power supply, which may be a battery or a connection to a permanent power source, such as a wall outlet.

While the processing unit 20, the memory device 25, the network interface 30, and the data memory device 40 are shown in FIG. 1 as separate components, it is understood that some or all of these components may be integrated into a single electronic component. Rather, FIG. 1 is used to illustrate the functionality of the network device 10, not its physical configuration.

Further, in some embodiments, the memory device 25 used to store the instructions 26 may be writable. For example, it may be a FLASH ROM or an electrically erasable ROM (EEROM). In this way, it is possible to load a new software image, which includes the instructions 26, into the network device 10.

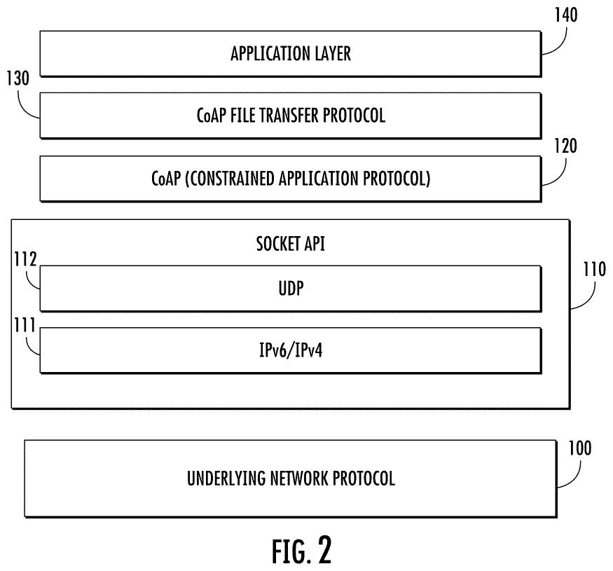

Within the instructions, there may be a network stack, which is used to perform all operations related to communication over the wireless network. This network stack may incorporate a plurality of different network protocols. FIG. 2 shows one example of the software layers that may be included in the network stack. At the lowest layer, there may be an underlying network protocol 100, such as Wi-SUN, OpenThread, WiFi or another network that supports the IP stack and UDP. Above this underlying network protocol 100 is a network programming interface, which may be referred to as the socket application programming interface (API) 110. The socket API 110 may include various protocols, such as User Datagram Protocol (UDP) layer 112 and Internet Protocol (IP) layer 111. The IP layer 102 may support IPv4, IPv6, or both. Above the socket API 110 is the constrained Application protocol (CoAP) layer 120.

CoAP is a lightweight network protocol primarily intended for devices that are resource limited. The CoAP protocol utilizes the IP stack and UDP. The CoAP specification defines a packet format, having a header and a payload. The header includes various parameters, including:
Message type;
Message Code;
Message ID;
URI-Path; and
Other options.

CoAP defines confirmable and non-confirmable message types. Confirmable messages must be acknowledged by the receiving device, while non-confirmable messages are not acknowledged.

CoAP defines several different message codes. One such message code is a request, which is further categorized into PUT, POST and GET requests. A GET request is a request for the resource identified by the request. A response to the GET request provides that resource in its payload.

A PUT request is a request that the resource identified by the request be updated or created with the value contained in the payload. A response to a PUT request may indicate that the requested action has been performed.

The Message ID is a 16 bit value that can be used to detect message duplication or other purposes.

The URI-Path may be used to designate a specific resource within the server or the client.

Additionally, as noted above, the CoAP specification also defines a payload that may accompany the header. The payload may be up to 1024 bytes, although smaller payloads are also permitted.

Above the CoAP layer 120 is the CoAP File Transfer Protocol layer 130. The CoAP File Transfer Protocol layer 130 interacts with the CoAP layer 120 to transfer large files to and from the device. The mechanism to transfer these files is explained below.

Above the CoAP File Transfer Protocol Layer 130 is the application layer 140, which controls the high level functionality of the device and utilizes the CoAP File Transfer Protocol.

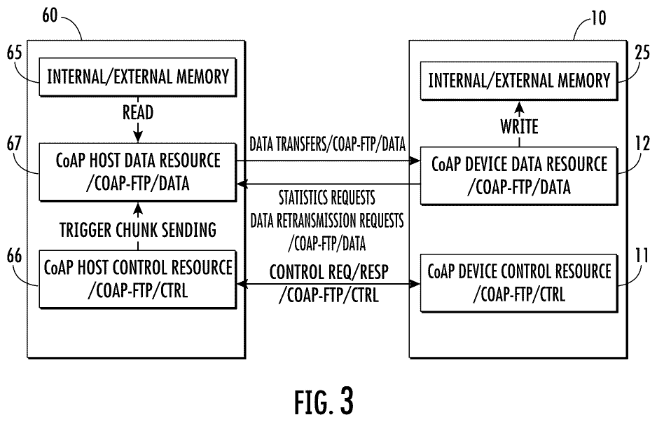

FIG. 3 shows a diagram that includes the network device 10, and a host device 60, which contains the file to be transferred. The host device 60 may have a similar architecture to the network device 10 (as shown in FIG. 1). In some embodiments, the host device 60 may have a larger capacity memory device and a more powerful processing unit. Further, in some embodiments, the host device 60 may have a permanent power supply, such as a wall outlet. In other embodiments, the architecture of the network device 10 and the host device 60 may be identical. Each device possesses a memory device 25, 65. The memory device 65 in the host device 60 contains the data to be transferred, while the memory device 25 may define the location where the transferred data will be stored in the network device 10.

In this embodiment, two different resources are defined for the network device 10 and the host device 60. The first resource is referred to as the Control Resource and is responsible for handling the logistics of the file transfer. This includes exchanging parameters associated with the file, such as name and size and parameters associated with the transfer, such as data chunk size. For example, this Control Resource receives requests to download a file or to upload a file to a remote device. In FIG. 3, this resource is referred to as the CoAP Host Control Resource 66 in the host device 60 and the CoAP Device Control Resource 11 in the network device 10. This resource may be a discoverable public resource.

The second resource is referred to as the Data Resource and is concerned with all aspects of the data transfer itself, including initial transmission and retransmissions. In FIG. 3, this resource is referred to as the CoAP Host Data Resource 67 in the host device 60 and the CoAP Device Data Resource 12 in the network device 10. This resource may be hidden and not discoverable.

In this embodiment, two different URI-Paths (/coap-ftp/ctrl and /coap-ftp/data) are used to access the Control Resource and the Data Resource, respectively. Having defined the basic structure of the software used for the file transfer protocol, a more detailed description of the file transfer protocol will be provided.

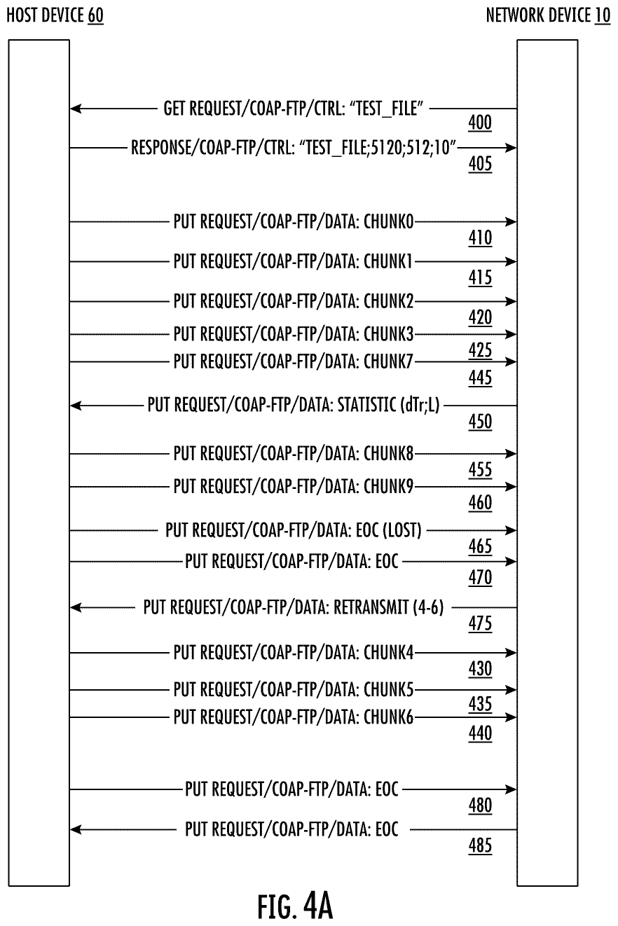

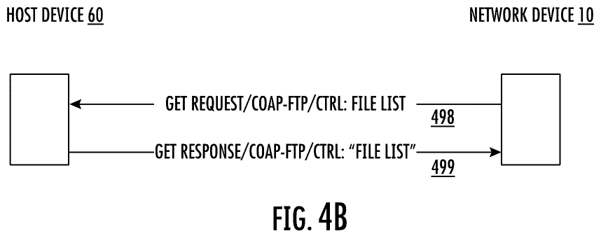

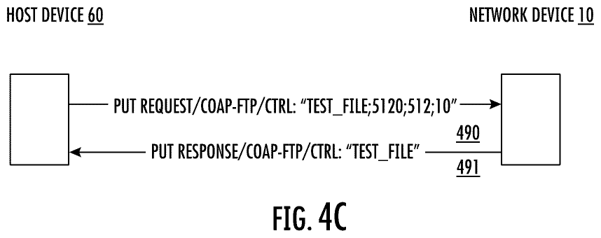

FIG. 4A shows the communications between the network device 10 and the host device 60 according to one embodiment. The communications are shown in chronological order. In this embodiment, the network device 10 initiates the file transfer. However, in other embodiments, the host device 60 may initiate the file transfer, as described with respect to FIG. 4C.

First, as shown in line 400, the network device 10 issues a GET request to the host device 60. This GET request is directed to the CoAP Host Control Resource 66 on the host device 60 and requests a specific file, called “test_file”. The name of the desired file may be transmitted in the payload of the GET request.

Note that in certain embodiments, the network device 10 may not know the name of the file that it requires. Thus, in certain embodiments, as shown in FIG. 4B, the network device 10 may request the list of available files. This may be accomplished by transmitting a GET request directed to the CoAP Host Control Resource 66 on the host device 60 with no payload or a unique payload, as shown in line 498. If this happens, the host device 60 may respond with a response to the GET request that includes a list of available files in the payload, as shown in line 499. The network device 10 may then select one of these files and proceed with line 400 in FIG. 4A. Note that in some embodiments, the available files for the network devices may be restricted, such that, without sufficient permission, the file cannot be accessed or downloaded from the host device 60.

Returning to FIG. 4A, in response to the GET request from the network device 10, the host device 60 may respond with a content response (see line 405). This content response is directed to the CoAP Device Control Resource 11 of the network device 10 and the payload of this content response provides the various file and transfer parameters, such as file name, file size, number of data chunks and chunk size. This information may be provided in any suitable format, which is not limited by this disclosure. Note that the information contained in this content response may vary. For example, in certain embodiments, the data chunk size is fixed and is therefore not communicated in this response. In other embodiments, the number of data chunks is not transmitted as it may be calculated based on file size and data chunk size.

Next, as shown in line 410, the host device 60 begins the file transfer. This is done by issuing a PUT request to the CoAP Device Data Resource 12 of the network device 10. The Message ID of this PUT request may be defined as the identifier of the data chunk being transmitted. For example, for the first data chunk, the Message ID may be set to 0 (or 1). The payload of this PUT request contains the actual data. This may be referred to a Data Chunk PUT request.

Lines 415, 420, 425 of FIG. 4A show subsequent Data Chunk PUT requests for the second, third and fourth data chunks, respectively. In certain embodiments, the host device 60 always sends the data chunks in the correct order, such that data chunk 3 follows data chunk 2, which follows data chunk 1. Again, the Message ID may contain the identifier of the data chunk being transmitted, while the payload contains the actual data. Note that the next several data chunks were lost and never received by the network device 10. Thus, as shown in line 445, the next Data Chunk PUT request received by the network device 10 provided the data for the seventh data chunk. Note that the host device 60 also transmits Data Chunk PUT requests for the eighth, and ninth data chunks, as shown in lines 455, 460, respectively.

At this point, the host device 60 believes that all of the data chunks have been transmitted, and therefore transmits a PUT request indicating that all of the chunks have been sent, as shown in line 465. This may be referred to as an EOC (End Of Chunks) Put request. In a EOC Put Request, the Message ID is set to a predetermined value, which is not used by the Data Chunk PUT requests used to transmit data chunks. For example, very large values, such as 0xFFFF, may be used as the Message ID. Further, there may be no payload or a predetermined sequence of bytes associated with the payload of this EOC Put Request.

The host device 60 expects a response to this EOC Put request. Therefore, when a response is not transmitted by the network device 10, the host device 60 retransmits the EOC Put Request, as shown in line 470.

The network device 10, having received the EOC Put request, determines whether it has received all of the data chunks that were expected. Specifically, the content response to the initial GET request indicated the number of data chunks that would be transmitted (see line 405). Based on the number of data chunks expected, and the Message IDs of the Data Chunk PUT requests, the network device 10 assembles a list of missing data chunks. This may be done in a plurality of ways. In one embodiment, the network device 10 may create a bit map where there is one bit associated with each expected data chunk. When that data chunk is received, the bit map is updated. When the EOC Put request is received, the network device 10 reviews the bitmap to determine the identity of the data chunks that were not received. In another embodiment, the network device 10 may note when a non-sequential data chunk is received. The network device 10 then adds all of the data chunks that were missed to a list. If one of the missing data chunk arrives out of order, it may be removed from the list. This list is then transmitted when the EOC Put request is received.

Thus, as shown in line 475, the network device 10 transmits a response to the EOC PUT request, which lists the data chunks that it did not receive. This response, which is referred to as a Retransmission List request, may use the same Message ID as the EOC PUT request. The payload may be the identifiers for each data chunk that was not received. In one embodiment, a first delimiter is used to separate these identifiers. In another embodiment, a predetermined sequence of bytes may be disposed at the beginning of the payload to identify this message as a Retransmission List request. The payload in the Retransmission List request may be a list of individual identifiers separated by the first delimiter. In another embodiment, if consecutive data chunks were not received, the payload may include a range of identifiers that need to be retransmitted. For example, in FIG. 4A, the payload may be the list of 4,5,6 in some embodiments and may be the range of 4-6 in other embodiments.

In response to the Retransmission List request, the host device 60 retransmits the fourth, fifth, and sixth data chunks, as shown in lines 430, 435 and 440, respectively, as Data Chunk PUT requests.

After transmitting all of the lost data chunks, the host device 60 again transmits a EOC PUT request, as shown in line 480. Since the network device 10 has now received all of the data chunks, it transmits a response to the PUT request that indicates that the file transfer was successful, referred to as a Transfer Successful PUT request. This Transfer Successful PUT request may use the same Message ID as the EOC PUT request. Further, there may be no payload associated with this response. The lack of a payload may be used by the host device 60 to determine that this is a Transfer Successful PUT request. In other embodiments, a specific sequence of bytes may be used in the payload to denote that this is a Transfer Successful PUT request.

As noted above, in some embodiments, the host device 60 may initiate the file transfer. This scenario is shown in FIG. 4C. In this embodiment, the host device 60 begins by transmitting a PUT request to the network device 10, as shown in line 490. The Message ID of this PUT request may be any value, while the payload may include file parameters and the transfer parameters, such as the file name and length, the number of chunks needed to transmit the file and the size of each data chunk. In response, the network device 10 may transmit a PUT response, with the file name in its payload. This serves to confirm that the network device 10 received the PUT request and is ready for the file transfer to occur. The rest of the sequence is as shown in FIG. 4A, starting at line 410.

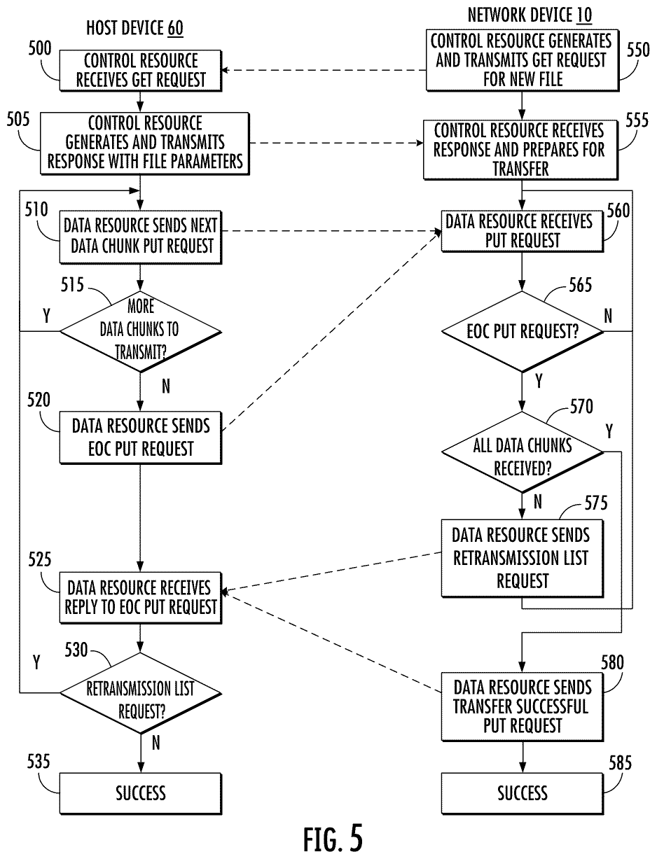

FIG. 5 illustrates a flowchart showing the operation of the host device 60 and the network device 10 during the sequence shown in FIG. 4A. The left side of the figure shows the operation of the host device 60, while the right side shows the operation of the network device 10.

First, as shown in Box 550, the sequence begins with the CoAP Device Control Resource 11 of the network device 10 generating and transmitting a GET request for a new file to the CoAP Host Control Resource 66 of the host device 60. This GET request is received by the CoAP Host Control Resource 66 of the host device 60 (see Box 500). In response, as shown in Box 505, the CoAP Host Control Resource 66 of the host device 60 generates and transmits the response to this GET request. As described above, this response includes the file name, its length, the number of data chunks needed and the size of each data chunk. In Box 555, the CoAP Device Control Resource 11 of the network device 10 receives the response and prepares for the transfer. At this point, the subsequent requests between the two devices are directed toward the respective Data Resource of each device.

As shown in Box 510, the CoAP Host Data Resource 67 of the host device 60 transmits the next data chunk to the network device 10. This data chunk is received and processed by the CoAP Device Data Resource 12 of the network device 10, as shown in Box 560. The host device 60 then checks if there are more data chunks to transmit as shown in Decision Box 515. As long as there are more data chunks, the CoAP Host Data Resource 67 of the host device 60 will continue to send Data Chunk PUT requests to the network device 10 (see Box 510). The timing between successive transmissions of the Data Chunk PUT requests may be determined by the host device 60, as described below.

Once all of the data chunks have been transmitted, the CoAP Host Data Resource 67 of the host device 60 transmits a EOC PUT request, as shown in Box 520.

At the network device 10, all of these data chunk PUT requests are processed by the CoAP Device Data Resource 12. After receipt of each PUT request, the network device 10 checks whether this is a Data Chunk PUT request or a EOC PUT request, as shown in Decision Box 565. If it is a Data Chunk PUT request, the CoAP Device Data Resource 12 prepares to receive the next PUT request (see Box 560). If, on the other hand, this is a EOC PUT request, the network device 10 checks to see if all of the data chunks have been received (see Decision Box 570).

If all of the data chunks have been successfully received, the network device 10 transmits a Transfer Successful request in response to the EOC PUT request, indicating success, as shown in Boxes 580 and 585. If, however, all of the data chunks have not been successfully received, the network device 10 transmits a Retransmission List request in response to the EOC PUT request, as shown in Box 575.

At the host device 60, the response to the EOC PUT request is received, in Box 525. Note that if a response is not received within a certain time interval, the host device 60 may retransmit the EOC PUT request. The host device 60 checks if this is a Retransmission List request, as determined in Decision Box 530. If so, the CoAP Host Data Resource 67 begins the process of retransmitting any lost packets by returning to Box 510. The identifiers for the lost packets are contained in the payload of the Retransmission List request packet. If this is not a Retransmission List request, then the transfer is successful, as shown in Box 535.

Thus, in each of these embodiments, the file transfer is performed using CoAP without the use of acknowledgments transmitted after each message. In other words, only non-confirmable messages are used. Rather, the network device 10 only transmits responses to the host device 60 when the host device 60 indicates that it believes that the transfer has been completed by transmitting a EOC PUT request. In response, the network device 10 will either send a Transfer Successful PUT request indicating that the transfer is complete, or a Retransmission List PUT request, indicating which data chunks it did not receive, or received in error.

Further, while the above description discloses a host device 60 and a network device 10, it is understood that these devices may be peers in a peer-to-peer network. Furthermore, in another embodiment, the host device 60 transmits the PUT requests using a multicast address such that multiple network devices may receive the file at the same time. In this embodiment, each network device 10 may issue a Retransmission List request after receipt of a EOC PUT request. The host device 60 may then concatenate all of the information in the Retransmission List requests from the various network devices 10 and retransmit any data chunk that was not received by at least one of the network devices 10. Of course, the retransmission of lost data chunks may be performed in another manner, if desired.

For example, in another embodiment, the host device 60 may not transmit the EOC PUT request. Rather, each network device that is receiving the multicast packets may use an internal timer to determine when a packet has been lost. Specifically, after a data chunk is received, the timer is started. If the timer expires before the next data chunk is received, it is assumed that the packet was lost. Upon determination that a packet is lost, that network device may transmit a Retransmission List request, as described above. Additionally, in some embodiments, the host device 60 may not require a Transfer Successful request from all of the network devices. Rather, the host device 60 may start a timer after the last data chunk has been transmitted and if no Retransmission List requests are received before the timer expires, the host device 60 assumes that the transfer was successful.

As mentioned above, in some embodiments, the interval between transmission of successive Data Chunk PUT request (defined as “T”) may be constant. In other embodiments, the interval between transmissions of successive Data Chunk PUT requests may be varied. This may be done based on feedback from the network device 10. Returning to FIG. 4A, note that after receipt of an out-of-order Data Chunk PUT request (see line 445), the network device 10 may transmit a Statistics PUT request back to the CoAP Host Data Resource 67 of the host device 60 (see line 450). This Statistics PUT request may include various parameters measured by the network device 10, such as the number of lost packets or the percentage of packets that were lost (which, in FIG. 4A, is identified as “L”). Additionally, other parameters, such as the time between successive received Data Chunk PUT requests (“Tr”), and/or the change in the received transmission interval (“dTr”), which is determined using at least 2 received transmission intervals (Tr), may also be provided in the payload of the Statistics PUT request. In one embodiment, the “dTr” value may be calculated as:
newest_Tr, less the previous_Tr,
where the newest_Tr is defined as Timestamp(newest_packet)−Timestamp(previous_packet) and previous_Tr is defined as Timestamp(previous_packet)−Timestamp(twice_previous_packet).

The “dTr” metric may be indicative of the stability of the network. For example, if packets are arriving at constant intervals, the range of dTr values will be very small, indicating that the network is stable. In contrast, a large range of dTr values indicates that there may be network instability or uncertainty. Further, a negative value of “dTr” may indicate that the network is becoming more stable. Of course, additional or different parameters may be provided as well. For example, the jitter associated with Tr, the rate/count of out of order packets, and other parameters may be used in addition to or instead of these parameters. The Statistics PUT request may use the same Message ID as the EOC PUT request. The host device 60 may determine that this is a Statistics PUT request based on the format of the payload. For example, a second delimiter, different from the delimiter used for the Retransmission List PUT request, may be used to separate the various parameters contained in the payload. Alternatively, a predetermined sequence of bytes may be disposed at the beginning of the payload to identify this as a Statistics PUT request.

Further, while FIG. 4A shows the Statistics PUT request being sent after an out-of-order or lost data chunk, other embodiments are also possible. For example, the network device 10 may send the Statistics PUT request at regular intervals, such as after a predetermined number of received Data Chunks, or after a predetermined duration of time.

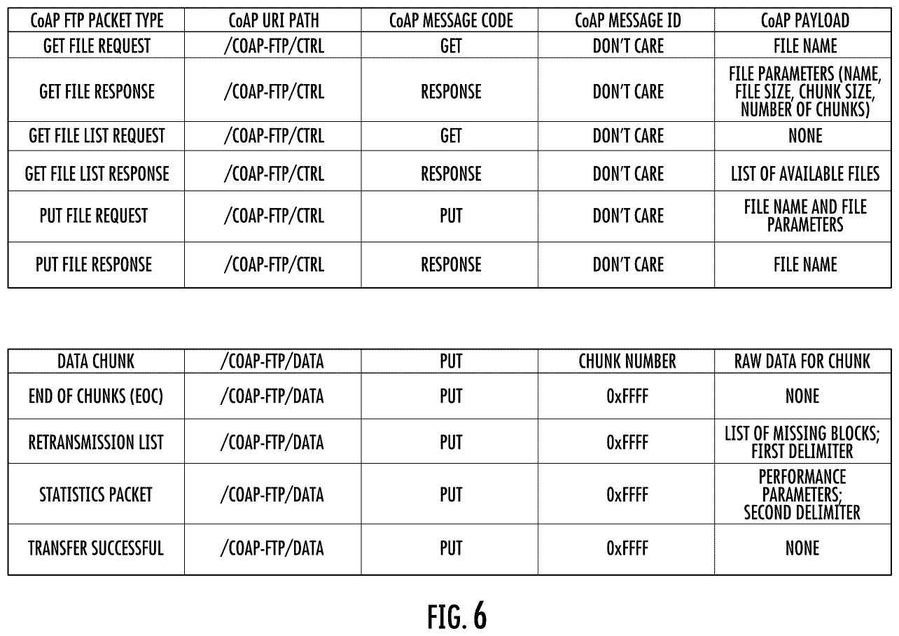

The format of the different requests and responses described above is shown in FIG. 6. Of course, this is one embodiment and these requests and responses may be encoded differently. For example, additional requests and responses may be defined for multi-cast operation.

Further, this protocol may be used for partial file transfers as well. For example, a network device may have received part of a new file before the connection was lost or there was a power failure. In this case, the network device 10 may respond to the response to the GET request (see line 405 in FIG. 4A) with a Retransmission List request, listing the data chunks that are required.

The Statistics PUT request may be processed by the host device 60, which may use this information to vary the interval between transmission of successive Data Chunk PUT requests.

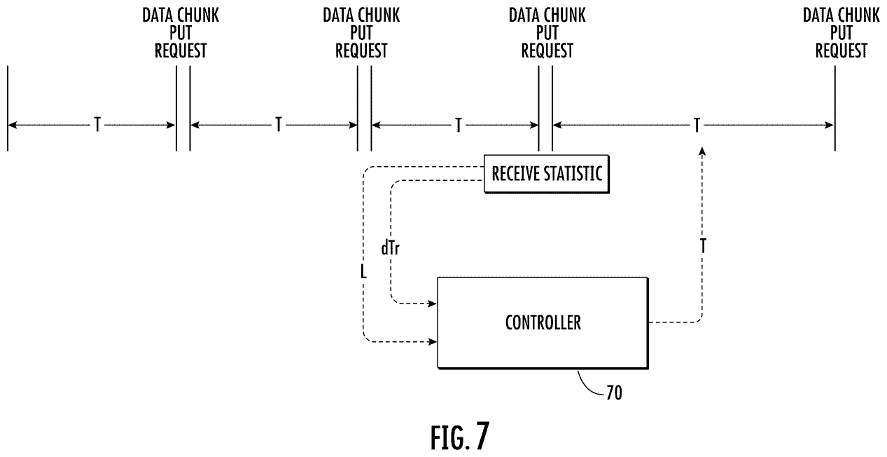

FIG. 7 shows one implementation of this variable time interval. In this embodiment, the host device 60 may include a controller 70. This controller 70 may be a hardware device, such as a specialized circuit or microcontroller. In other embodiments, this controller 70 may be a software program that receives the parameters in the Statistics PUT request and uses these parameters to determine an appropriate interval between transmission of successive Data Chunk PUT requests. For example, a high error rate may suggest that a longer interval between Data Chunk PUT requests is warranted. As an example, a large “dTr” range with a high percentage of lost packets indicates that the network is very unstable, and a larger transmission interval (“T”) should be used. Conversely, a low percentage of lost packets and a small “dTr” range indicate a very stable network, and the transmission interval (“T”) may be reduced.

In another embodiment, the controller 70 may be a fuzzy controller. In certain embodiments, fuzzy controller is a software program that receives a plurality of parameters in the Statistics PUT request as inputs and generates one output, which is the appropriate transmission interval (“T”) between successive Data Chunk PUT requests. The fuzzy controller may comprise three stages. The first stage is the fuzzification, where the discrete values of the parameters in the Statistics PUT request are converted into fuzzy sets. For example, the “dTr” parameter may be converted into input fuzzy sets, which may include more membership functions, such as “very steady”, “steady”, “unsteady” and “very unsteady”. Similarly, the packet loss percentage may be converted into input fuzzy sets, which may include more membership functions such as “very low”, “low”, “medium” and “high”. The output, “T” may be categorized as an output fuzzy set with a plurality of membership functions. In one embodiment, 16 membership functions are used to categorize the transmission interval. The second stage is the inference stage, which comprises a series of IF/THEN statements that uses the input fuzzy sets to determine the appropriate output fuzzy sets. The third stage is the defuzzification of the output. The resulting fuzzy sets are then converted into a discrete value, which represents the new transmission interval (“T”).

The present system has many advantages. In one test, which was conducted using a Wi-Sun network operating at Field Area Network (FAN) 1.1 North America, PHY Mode ID: 2, Channel Plan ID: 1, 2-FSK 50 Kb/s 902.2 MHz, a 630 kByte file was transferred from a host device to a network device. This file was transferred using Trivial File Transfer Protocol (TFTP) and the total elapsed time was measured. The total transfer time was found to be over 8 minutes using 512 byte payloads. This file transfer was then retransmitted using the CoAP file transfer protocol described herein. Depending on the interval between Data Chunk PUT requests, the total transfer time was reduced by between 23% and 47%. This represents a significant improvement in file transfer time. Furthermore, this new file transfer protocol is easily implemented on any network device that already supports IP stack and UDP. Additionally, this CoAP file transfer protocol does not mandate any specific file format.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A system for wirelessly transferring a file, comprising:
a host device; and
a network device;
wherein constrained application protocol (CoAP) is used to transmit requests and responses between the host device and the network device;
wherein the file is divided into a plurality of data chunks;
wherein only non-confirmable messages are used to transfer the file; and
wherein the host device comprises a controller that modifies at least one parameter of the transfer based on feedback from the network device.

2. The system of claim 1, wherein the at least one parameter of the transfer that is modified comprises an interval between transmission of successive data chunk PUT requests, referred to as a transmission interval (T).

3. The system of claim 2, wherein the feedback comprises a number or percentage of data chunk PUT requests that were not received by the network device.

4. The system of claim 2, wherein the feedback comprises a change in received transmission interval (dTr).

5. The system of claim 1, wherein the controller comprises a fuzzy controller.

6. A method of wirelessly transferring a file between a host device and a network device, comprising:
using constrained application protocol (CoAP) to transmit requests and responses between the host device and the network device;
wherein the file is divided into a plurality of data chunks; and
only non-confirmable messages are used to transfer the file.

7. The method of claim 6, wherein the host device uses data chunk PUT requests to transmit the file to the network device, wherein each data chunk PUT request contains one of the plurality of data chunks.

8. The method of claim 7, wherein the host device transmits an End of Chunks (EOC) PUT request to indicate that all of the plurality of data chunks have been transmitted.

9. The method of claim 8, wherein the network device transmits a Retransmission List request in response to the EOC PUT request if all of the plurality of data chunks were not received, wherein the Retransmission List request contains a list of identifiers of data chunks that were not received and wherein, in response to the Retransmission List request, the host device uses the list of identifiers to retransmit data chunks that were not received using data chunk PUT requests.

10. The method of claim 8, wherein the network device transmits a Transfer Successful request in response to the EOC PUT request if all of the plurality of data chunks were received.

11. The method of claim 6, wherein the network device transmits a GET request to the host device to request the transfer of the file, and wherein the host device transmits a response to the GET request that provides parameters about the file and/or the transfer, wherein the parameters are one or more of file name, file size, data chunk size or number of data chunks.

12. The method of claim 6, wherein the network device transmits a GET request to the host device to request a list of available files, the host device responds to the GET request with a list of available files, the network device selects a file from the list of available files and transmits a GET request to the host device to request the transfer of the file.

13. The method of claim 6, wherein the network device transmits a Statistics PUT request to the host device, the Statistics PUT request comprising parameters associated with transmission of the plurality of data chunks.

14. The method of claim 13, wherein the network device transmits the Statistics PUT request after a missing or lost data chunk is detected.

15. The method of claim 13, wherein the host device uses the parameters associated with the transmission of the plurality of data chunks to modify a transmission interval, which is defined as an interval between transmission of successive data chunk PUT requests.

16. The method of claim 13, wherein the parameters associated with transmission of the plurality of data chunks comprise at least one of a number of data chunks that were not received, a percentage of data chunks that were not received, or a change in received transmission interval.

17. The method of claim 15, wherein the host device uses a fuzzy controller to modify the transmission interval.

18. A network device adapted to receive a file from a host device, the network device comprising:
a network interface;
a processing unit; and
a memory device in communication with the processing unit, containing instructions, which when executed by the processing unit, enable the network device to:
receive a plurality of Data Chunk PUT requests from the host device, wherein each Data Chunk PUT request is transmitted using non-confirmatory messages via constrained application protocol (CoAP), and wherein each Data Chunk PUT request contains a chunk of data associated with the file;
receive an End Of Chunks (EOC) PUT request from the host device, wherein the EOC PUT request is transmitted using a non-confirmatory message via CoAP; and
transmit a request back to the host device in response to the EOC PUT request, wherein the request is transmitted using a non-confirmatory message via CoAP.

19. The network device of claim 18, wherein the network device transmits a Transfer Successful request if all of the chunks of data were successfully received, and transmits a Retransmission List request if one or more data chunks were not received.

20. The network device of claim 18, further comprises instructions, which when executed by the processing unit, enable the network device to transmit a GET request to the host device to request the transfer of the file, and receive a response from the host device that provides parameters about the file and/or the transfer, wherein the parameters are one or more of file name, file size, data chunk size or number of data chunks.
